(19) United States
(12) Patent Application Publication
(10) Pub. No.: US 2019/0180330 A1
(43) Pub. Date: Jun. 13, 2019

(54) PREMIUM CONTENT BID MODIFIER

(71) Applicant: Google LLC, Mountain View, CA (US)

(72) Inventors: Avi Fein, San Francisco, CA (US); Lane Shackleton, San Francisco, CA (US); Sibu Ray, Redondo Beach, CA (US); Xifei Huang, San Bruno, CA (US); Lena Elizabeth Cardell, San Francisco, CA (US)

(21) Appl. No.: 14/817,079

(22) Filed: Aug. 3, 2015

(51) Int. Cl. G06Q 30/02

(52) U.S. Cl. CPC G06Q 30/0275

(57) ABSTRACT

A system and method are disclosed for selecting advertisements for premium and non-premium content and delivering the advertisements and content to client media players. In one implementation, a request is received for a premium content item by a media player. A winning bid is determined for an auction pertaining to the request, where the winning bid is based on an advertiser-specified bid value and on an advertiser-specified bid modifier for advertisement placement in premium content. An advertisement associated with the winning bid is provided to the second media player for presentation with the premium content item.

### TECHNICAL FIELD

Aspects and implementations of the present disclosure relate to data processing, and more specifically, to delivering content and advertisements to client media players.

### BACKGROUND

Media players may present advertisements to users in conjunction with requested content (e.g., video clips, etc.). Selection of a particular advertisement for presentation may be determined by an auction, in which advertisers compete for placement of their advertisements.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a first request for a non-premium content item by a first media player executing on a first client device is received. A processing device determines a winning bid for a first auction pertaining to the first request, where the winning bid for the first auction is based on an advertiser-specified bid value for advertisement placement in non-premium content. An advertisement associated with the winning bid of the first auction is caused to be provided to the first media player for presentation with the non-premium content item. A second request for a premium content item by a second media player executing on a second client device is received, and the processing device determines a winning bid for a second auction pertaining to the second request, where the winning bid for the second auction is based on the advertiser-specified bid value and on an advertiser-specified bid modifier for advertisement placement in premium content. An advertisement associated with the winning bid of the second auction is caused to be provided to the second media player for presentation with the premium content item.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an exemplary system architecture, in accordance with one implementation of the present disclosure.

FIG. 2 depicts an illustrative graphical user interface (GUI), in accordance with one implementation of the present disclosure.

FIG. 3A depicts a flow diagram of aspects of a method for determining an advertisement to deliver to a client media player requesting a content item.

FIG. 3B depicts a flow diagram of aspects of a method for facilitating delivery of an advertisement to a client media player requesting a content item.

FIG. 4 depicts a block diagram of an illustrative computer system operating in accordance with aspects and implementations of the present disclosure.

### DETAILED DESCRIPTION

Aspects and implementations of the present disclosure are disclosed for selecting advertisements for premium and non-premium content and delivering the advertisements and content to client media players. In some examples, a content item (e.g., a video clip, an audio clip, an image, etc.) may be designated as premium content (e.g., via a metadata field or attribute, etc.) based on one or more factors such as the author of the content item, the subject matter of the content item, a person appearing in the content item, the number of views of the content item, and so forth. For example, a content item may be designated as premium content if it is associated with a prominent entity (e.g., a highly regarded actor, director, politician, writer, etc.) or a prominent event (e.g., a major sporting event, an award-winning performance, etc.), and is therefore presumed to exude prestige and/or attract a much higher level of interest from end users than regular, non-premium content that does not have such associations.

Advertisements are often purchased via audience targeting. For example, in the case of a content sharing platform, it may be desirable to advertisers for their advertisements to be targeted to users of the content sharing platform based on a user's age, gender, geolocation, interests, and so forth. In addition to reaching the desired audience, however, advertisers also care about the particular content in which the advertisement is presented. Consequently, advertisers may value premium content (e.g., an award-winning video, a popular sporting event, etc.) due to a perceived “halo effect” of being associated with that premium content.

Premium content, however, is by its very nature a scarce commodity, as it commands large audiences and possesses positive brand affinity. Consequently, if an advertiser explicitly targets premium content in addition to targeting particular users, the reach of their advertisement campaign may be dramatically reduced (e.g., very few eligible impressions).

Aspects and implementations of the present disclosure enable advertisers to achieve a balance of audience targeting and premium content targeting, without sacrificing reach. In one implementation, advertisers submit a bid value for advertisement placement in non-premium content (e.g., $10, etc.), and a bid modifier for advertisement placement in premium content, thereby enabling the bid to be revised upward for premium content. In some aspects, the bid modifier may be a multiplicative factor to be applied to the bid value (e.g., 1.5, 2.0, 160%, etc.), while in some other aspects the bid modifier might be an additive delta value (e.g., bid value+10, bid value+20, etc.), while in yet other examples the bid modifier might be an arbitrary function (e.g., 2×+5, min{3×, $50}, etc.) that is formulated by the advertiser, and might be applied to the bid value via a function pointer.

When a media player executing on a client device (e.g., a smartphone, a personal computer, etc.) requests a non-premium content item from the content sharing platform, a winning bid is determined via auction, where the auction bids are the advertiser-specified bid values for placement in non-premium content. When a media player requests a premium content item (e.g., a non-premium video clip, a non-premium audio clip, etc.) from the content sharing platform, a winning bid is determined via auction, where the auction bids are based on both the advertiser-specified bid values for placement in non-premium content, and the advertiser-specified bid modifiers for placement in premium content. For example, if an advertiser specifies a bid value of $10 for non-premium content and a bid modifier of 2.5 for premium content, the advertiser's auction bid for placing an ad in non-premium content will be $10, and the advertiser's auction bid for placing an ad in premium content will be $25.

For both non-premium and premium content, a winning bid is determined for the auction, and an advertisement associated with the winning bid is provided to the media player for presentation along with the premium content item. In some examples in which both the content item and the advertisement are video clips, the advertisement may be presented prior to the content item, while in some other examples the advertisement may be presented at a certain point within the content item. In yet other examples, the advertisement may be a graphic overlay that is superimposed on a video content item.

Subsequently, the revenue generated for a content item is shared with a provider of the content item (e.g., a creator of the content item, the owner of a channel including the content item, etc.). By using bid modifiers for advertisement placement in premium content, providers of premium content are rewarded and encouraged to distribute their content via the content sharing platform.

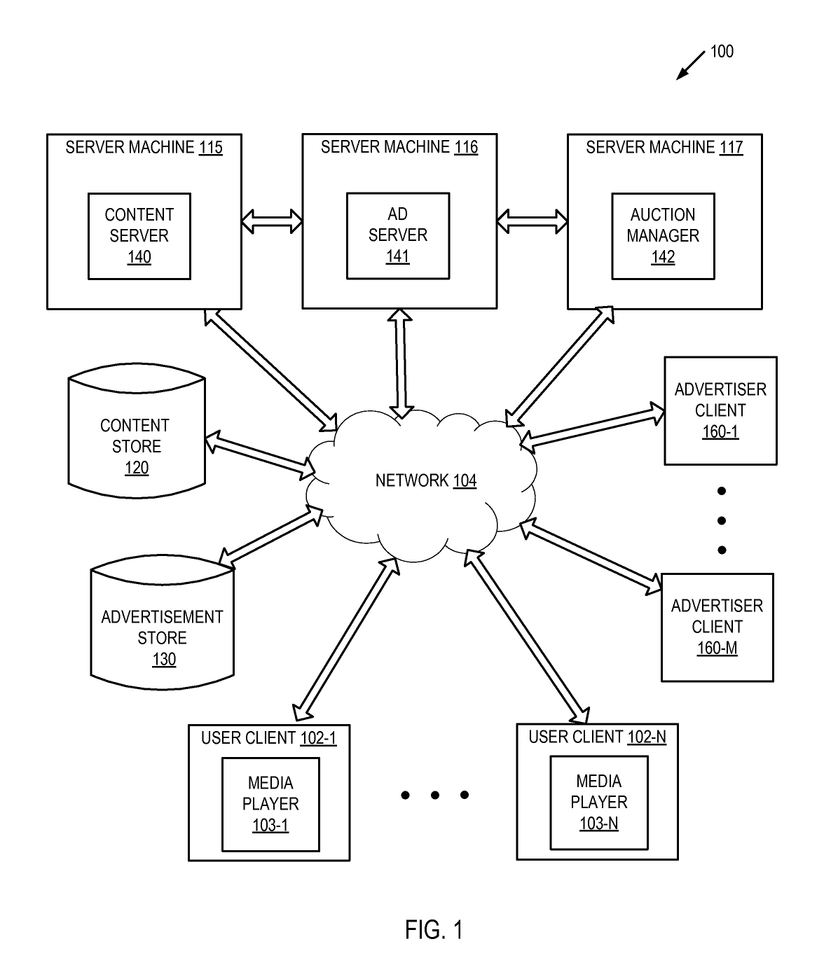

FIG. 1 illustrates an example system architecture 100, in accordance with one implementation of the present disclosure. The system architecture 100 includes a server machine 115, a server machine 116, a server machine 117, a content store 120, an advertisement store 130, user client machines 102-1 through 102-N, and advertiser client machines 160-1 through 160-M connected to a network 104, where M and N are positive integers. Network 104 may be a public network (e.g., the Internet), a private network (e.g., a local area network (LAN) or wide area network (WAN)), or a combination thereof.

Content store 120 is a persistent storage that is capable of storing content items (e.g., video clips, audio clips, images, etc.) as well as data structures to tag, organize, and index the media items. Content store 120 may be hosted by one or more storage devices, such as main memory, magnetic or optical storage based disks, tapes or hard drives, NAS, SAN, and so forth. In some implementations, content store 120 may be a network-attached file server, while in other embodiments content store 120 may be some other type of persistent storage such as an object-oriented database, a relational database, and so forth, that may be hosted by the server machine 115 or one or more different machines coupled to the server machine 115 via the network 104. The content items stored in the content store 120 may include user-generated media items that are uploaded by client machines, as well as media items from service providers such as news organizations, publishers, libraries and so forth. In some implementations, media store 120 may be provided by a third-party service, while in some other implementations media store 120 may be maintained by the same entity maintaining server machine 115.

Server machine 115 (hosting content server 140) and media store 120 may be part of a content sharing platform that allows a user to consume, upload, search for, approve of (“like”), dislike, and/or comment on media items. The content sharing platform may also include a website that may be used to provide a user with access to the media items. The content sharing platform may include any type of content delivery network providing access to content and/or media items.

The content sharing platform may include multiple channels (e.g., channels A through Z). A channel can be data content available from a common source or data content having a common topic or theme. The data content can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel.

Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. Once a user subscribes to a channel, the user can be presented with information from the channel's activity feed. An activity feed may be a list of recent activity associated with the user and occurring on the social network. If a user subscribes to multiple channels, the activity feed for each channel to which the user is subscribed can be combined into a syndicated activity feed. Information from the syndicated activity feed can be presented to the user. Although channels are described as one implementation of a content sharing platform, implementations of the disclosure are not limited to content sharing platforms that provide content items via a channel model. In particular, according to aspects of the present disclosure, the content sharing platform can provide users with access to content items that part of particular channels and/or to content items that are not part of any channels (e.g., independent content items or content items that are part of certain playlists or other content item collections). The content sharing platform may store the content items using the content store 120.

The content sharing platform may include or be otherwise associated with a mobile component that allows users to connect to, share information, and/or interact with each other using one or more mobile devices (e.g., phones, tablet computers, laptop computers, wearable computing devices, etc.) and/or any other suitable devices. For example, the mobile component may enable telephony communication, Short Message Service (SMS) messaging, Multimedia Message Service (MMS) messaging, text chat, video chat, and/or any other communication between users, and may present to a user a listing (e.g., activity feed, feed, stream, wall, etc.) of objects (e.g., posts, content items (e.g., videos, images, audios, etc.), status updates, favorability indications, tags, messages, etc.) provided by other users of the mobile platform. The mobile component may also include a content sharing aspect that allows users to upload, view, tag, share, and/or perform any other function on content, such as text content, video content, image content, audio content, etc. Other users of the content sharing platform may comment on the shared content, discover new content, locate updates, share content, and otherwise interact with the provided content.

Advertisement store 130 is a persistent storage that is capable of storing advertisements (e.g., video clip ads, audio clip ads, image overlays, etc.) as well as data structures to tag, organize, and index the media items. Advertisement store 130 may be hosted by one or more storage devices, such as main memory, magnetic or optical storage based disks, tapes or hard drives, NAS, SAN, and so forth. In some implementations, advertisement store 130 may be a network-attached file server, while in other embodiments content store 120 may be some other type of persistent storage such as an object-oriented database, a relational database, and so forth, that may be hosted by server machine 116 or one or more different machines coupled to the server machine 116 via the network 104. Advertisement store 130 and/or server machine 116 hosting ad server 141 may be part of the content sharing platform, or may be part of an independent system or systems that can communicate with the content sharing platform via network 104.

The user client machines 102-1 through 102-N may be personal computers (PCs), laptops, mobile phones, tablet computers, set top boxes, televisions, video game consoles, digital assistants or any other computing devices. Each user client machine 102-i, where i is an integer between 1 and N inclusive, runs a media player 103-i

that may be (or be part of) an application that allows a user to view content, such as images, videos, web pages, documents, etc. For example, the media player 103 may be part of a web browser that can access, retrieve, present, and/or navigate content (e.g., web pages such as Hyper Text Markup Language (HTML) pages, digital media items, etc.) served by a web server. The media player 103 may render, display, and/or present the content (e.g., a web page, a media viewer) to a user.

Media players 103 may be provided to client devices 102A through 102N by the server 115 and/or the content sharing platform. For example, media players 103 may be embedded media players (e.g., Flash® players or HTMLS players) that are embedded in web pages provided by the content sharing platform. In another example, the media players 103 may be (or be part of) applications (mobile applications or “apps”) that are downloaded from the server 115.

In one embodiment, the media player 103 is capable of submitting requests for user-selected content items (e.g., transmitting requests via network 104 to content server 140 of server machine 115, etc.), of submitting requests for advertisements to be presented with content items (e.g., transmitting requests via network 104 to ad server 141 of server machine 116, etc.), of receiving and presenting content items, and of receiving and presenting advertisements.

In general, functions described in one embodiment as being performed by the content server 240 can also be performed on the user client machines 102-1 through 102-N in other embodiments if appropriate. In addition, the functionality attributed to a particular component can be performed by different or multiple components operating together. The content server 140 can also be accessed as a service provided to other systems or devices through appropriate application programming interfaces, and thus is not limited to use in websites.

Each of server machines 115, 116 and 117 may be a rackmount server, a router computer, a personal computer, a portable digital assistant, a mobile phone, a laptop computer, a tablet computer, a camera, a video camera, a netbook, a desktop computer, a media center, or any combination of the above. Server machine 115 includes a content server 140 that is capable of receiving requests for content items from media players 103 (e.g., via a webpage, via an application, etc.). Server machine 116 includes an ad server 141 that is capable of receiving requests for advertisements. In some examples, the advertisement requests may be submitted by the media players 103, while in some other examples the advertisements requests may be submitted by content server 140. In one embodiment, ad server 141 is capable of receiving messages from auction manager 142 that identify advertisements stored in advertisement store 130 to be presented with content items. In some examples, ad server 141 may deliver the advertisements to media players 103, while in some other embodiments, the advertisements may be delivered by content server 140 to media players 103 in conjunction with content items.

Server machine 117 may include an auction manager 142 that is capable of receiving bid values and bid modifiers from advertiser client machines 160-1 through 160-M, of running auctions using the advertiser-provided bid values for ad placement in non-premium content items, and of running auctions using both the advertiser-provided bid values and the advertiser-provided bid modifiers for ad placement in premium content items. It should be noted that in some other implementations, content server 140, ad server 141, and auction manager 142 may be hosted by a single server machine, rather than on respsective server machines 115, 116 and 117.

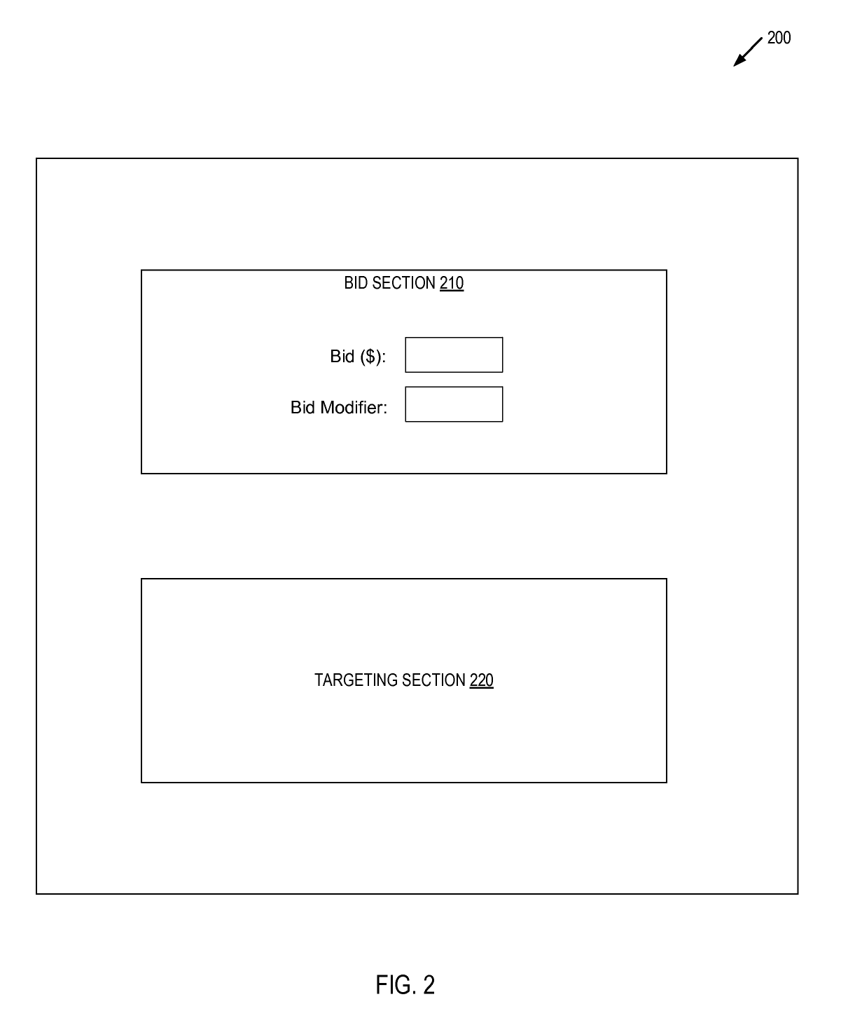

The advertiser client machines 160-1 through 160-M may be personal computers (PCs), laptops, smartphones, tablet computers, or any other computing devices. Each advertiser client machine 160-i, where i is an integer between 1 and M inclusive, is capable of presenting a graphical user interface (GUI) that enables an advertiser to provide bidding data for placing ads in non-premium and premium content (e.g., a bid value and a bid modifier), and audience targeting data (e.g., data pertaining to user demographics, user interests, etc.). The advertiser client machines 160 are also capable of transmitting the advertiser-provided data via network 104 to one or both of ad server 141 and auction manager 142. In some examples the GUI may be embedded within a webpage, while in some other examples the GUI may be part of an application (or “app”) on advertiser client machine 160 that is independent of a web browser. An illustrative GUI for obtaining bidding data and audience targeting data from advertisers is described in detail below with respect to FIG. 2.

Although implementations of the disclosure are discussed in terms of content sharing platforms, implementations may also be generally applied to any type of social network providing connections between users or to any type of content delivery platform providing content to end users. In situations in which the systems discussed here collect personal information about users, or may make use of personal information, the users may be provided with an opportunity to control whether the content sharing platform collects user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the content sharing platform, and/or server machines 115, 116 and 117, and/or any other component of the system 100.

FIG. 2 depicts an illustrative graphical user interface (GUI) 200 for obtaining information from an advertiser, in accordance with one implementation of the present disclosure. As noted above, in some embodiments GUI 200 may be presented via a webpage in a browser, while in some other embodiments GUI 200 may be presented in a dedicated application.

As shown in FIG. 2, GUI 200 comprises a first section 210 pertaining to bidding on advertisement placement, and a second section 220 pertaining to audience targeting. In one embodiment, bidding section 210 includes a first text field in which an advertiser can specify a bid value for non-premium content, denominated in dollars (e.g., $50, etc.), and a second text field in which the advertiser can specify a bid modifier for premium content. In some examples, the bid modifier might be a multiplier expressed as a coefficient (e.g., 1.5), while in some other examples the bid modifier might be a multiplier expressed as a percentage (e.g., 150%), while in yet other examples the bid modifier might be a delta value denominated in dollars (e.g., $20), while in still other examples the bid modifier might be an arbitrary function expressed symbolically (e.g., 2x+$10). It should be noted that when the bid modifier is an arbitrary function, an advertiser may specify the function using a symbolic formula or equation builder in some examples, while in some other examples the advertiser may specify the function via a string of symbols entered directly into the corresponding text field.

In one embodiment, targeting section 220 includes one or more graphical widgets (e.g., text fields, radio buttons, drop-down lists, etc.) that enable an advertiser to specify audience targeting parameters (e.g., gender, an age category, etc.). It should be noted that in some implementations, the data in the bidding and targeting sections may be applied to all advertisements associated with the advertiser, while in some other implementations the bidding and targeting sections may be specified on an individual basis for each of a plurality of advertisements associated with the advertiser, such that one advertisement might have different bid/bid modifier/targeting data than another advertisement. As discussed above, users of the content sharing platform media players are notified of the types of information collected about them (e.g., gender, age, viewing history, etc.), and are provided the opportunity to choose not to have such information collected and/or shared.

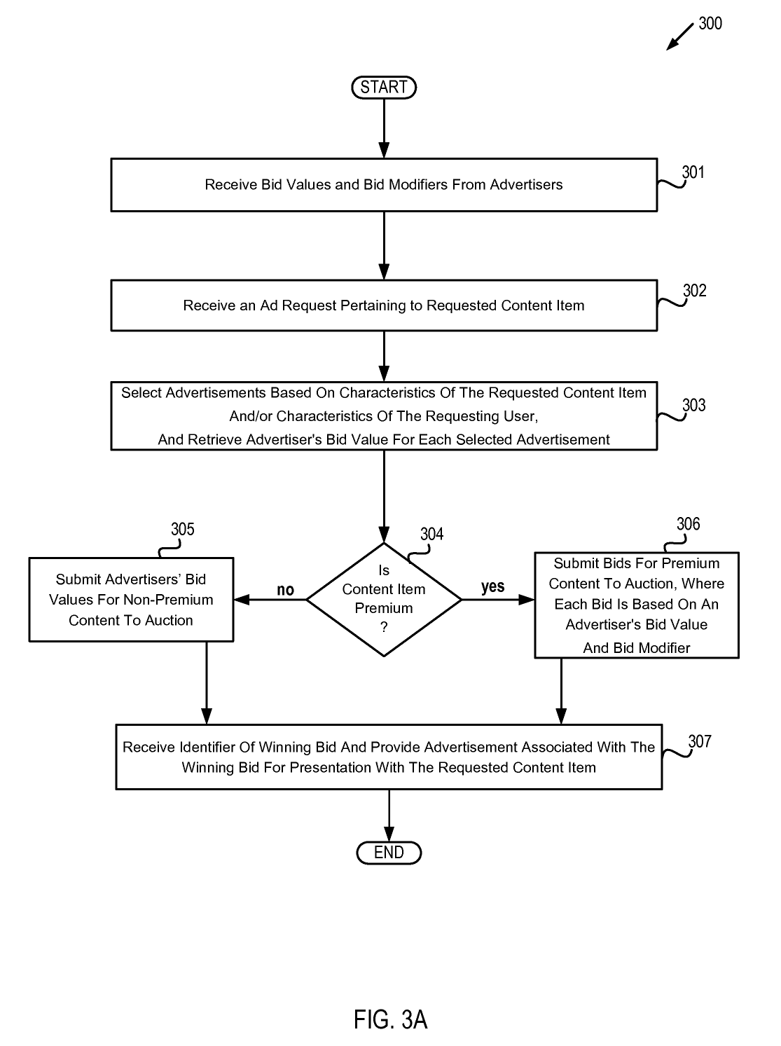

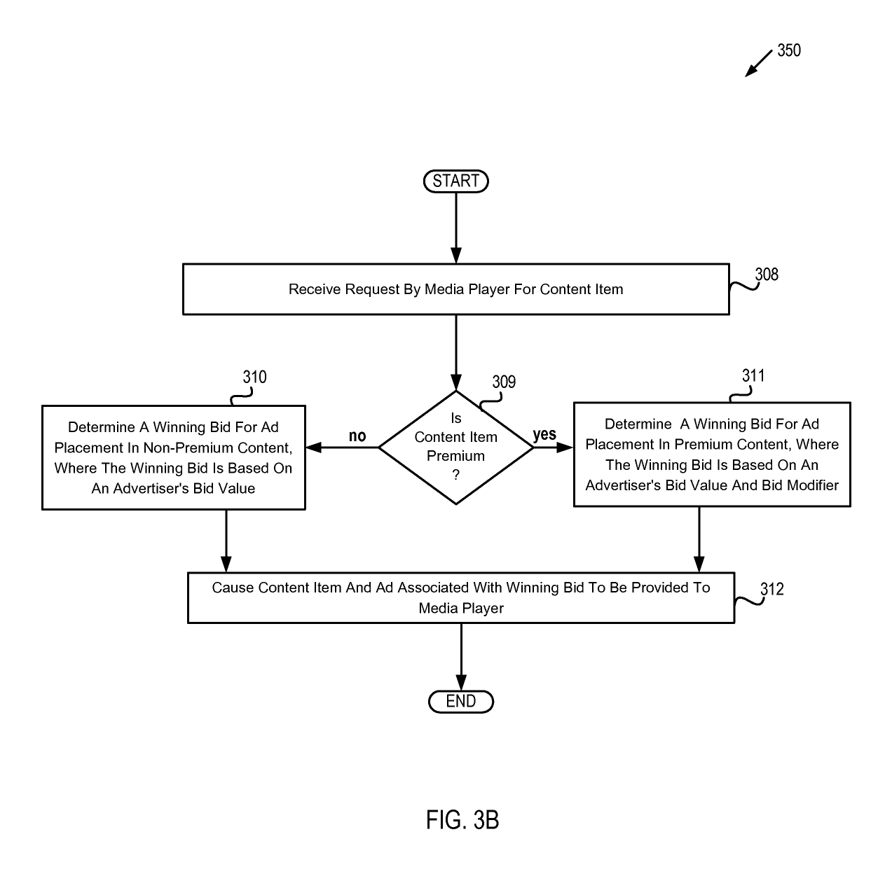

FIG. 3A depicts a flow diagram of aspects of a method 300 for determining an advertisement to deliver to a client media player requesting a content item. The method is performed by processing logic that may comprise hardware (circuitry, dedicated logic, etc.), software (such as is run on a general purpose computer system or a dedicated machine), or a combination thereof. In one implementation, the method is performed by server machine 116 of FIG. 1, while in some other implementations, one or more blocks of FIG. 3A may be performed by another machine not depicted in the figures.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 301, bid values for non-premium content and bid modifiers for premium content (e.g., content provided by a prestigious content author, content in which famous actors appear, content that has a high degree of virality, content provided by premium channels, etc.) are received from one or more advertisers. In accordance with one aspect, the bid values and bid modifiers are received by ad server 141 from advertisement clients 160, via network 104. In one example, the bid values and bid modifiers are stored in a data store associated with ad server 141.

Subsequently, at block 302, an advertisement for a content item can be requested. In accordance with some examples, a media player 103-i running on a client device 102-i may submit a request for the content item to the content sharing platform and/or content server 140, which may forward a corresponding ad request to ad server 141. In some other examples, the media player may submit two separate requests, one to content server 140 for the requested content item, and one to ad server 141 for an advertisement. The ad request may identify the requested content item (e.g., characteristics of the requested content item including an indicator specifying whether the requested content item is a premium content item or non-premium content item, an indicator specifying whether the requested content item is part of a channel that provides premium content or non-premium content, etc.), characteristics of a requesting user (e.g., age, gender, viewing history, geographic location, etc.), and so forth.

At block 303, advertisements are selected based on the characteristics of the requested content item and/or characteristics of the requesting user, and for each selected advertisement, a corresponding advertiser's bid value is retrieved. At block 304, execution branches based on whether the request content item is non-premium or premium. If the content item is non-premium, execution proceeds to block 305, otherwise execution continues at block 306.

At block 305, advertisers' bid values for non-premium content are submitted to an auction for determining an advertisement to deliver to the requesting media player. At block 306, bids for premium content are submitted to an auction for determining an advertisement to deliver to the requesting media player, where each bid is based on an advertiser's bid value and bid modifier (e.g., bid value*bid modifier, etc.).

At block 307, an identifier of a winning bid is received, and an advertisement associated with the winning bid is provided for presentation with the requested content item. In one example, the advertisement is provided to requesting client device 102-i directly or via the content sharing platform and/or content server 140.

FIG. 3B depicts a flow diagram of aspects of a method 350 for facilitating delivery of an advertisement to a client media player requesting a content item. The method is performed by processing logic that may comprise hardware (circuitry, dedicated logic, etc.), software (such as is run on a general purpose computer system or a dedicated machine), or a combination thereof. In one implementation, the method is performed by one or more of server machines 115 and 117 of FIG. 1, while in some other implementations, one or more blocks of FIG. 3B may be performed by another machine not depicted in the figures.

At block 308, a request by a media player for a particular content item is received. The request may be by a media player 103-i running on a user client 102-i. In one implementation, the request may be received by content server 140, and content server 140 may forward a corresponding ad request to ad server 141. The ad request may identify the requested content item (e.g., characteristics of the requested content item including an indicator specifying whether the requested content item is a premium content item or non-premium content item, an indicator specifying whether the requested content item is part of a channel that provides premium content or non-premium content, etc.), characteristics of a requesting user, etc. In some other examples, the media player may submit two separate requests, one to content server 140 for the requested content item, and one to ad server 141 for an advertisement, and either content server 140 or the media player can provide the above information about the requested content item to ad server 141.

At block 309, it may be determined whether the requested content item is a premium content item or a non-premium content item. In some implementations, this information on whether the requested content item is a premium content item or a non-premium content item may be provided to the ad server which can then submit relevant advertisers' bids to an auction associated with the requested content item. Execution further branches based on whether the requested content item is non-premium or premium. If the content item is non-premium, execution proceeds to block 310, otherwise execution continues at block 311.

At block 310, a winning bid for advertisement placement in non-premium content is determined, where the winning bid is based on an advertiser's bid value. After block 310, execution proceeds to block 312.

At block 311, a winning bid for advertisement placement in premium content is determined, where the winning bid is based on an advertiser's bid value and bid modifier (e.g., bid value*bid modifier, etc.).

In one embodiment, an auction is conducted (using either the bids for advertisement placement in non-premium content or the bids for advertisement placement in premium content), a winning bid is determined, and an advertisement associated with the winning bid is determined. In accordance with one aspect, the auction is conducted and the winning bid is determined by auction server 142. It should be noted that in some implementations, the auction may be based on one or more factors in addition to the values of the bids, rather than the highest bid always winning. Such additional factors might include metadata associated with the requested content item, data associated with the user's client device (e.g., geolocation, the type of client device, etc.), data associated with the user (e.g., age, gender, etc.), and so forth. As noted above, users of media players are notified of the types of information collected about them (e.g., gender, age, viewing history, geographic location, etc.), and are provided the opportunity to choose not to have such information collected and/or shared. When a user chooses not to have such information collected, this information will not be available for use in the auction.

At block 312, the content item and the advertisement determined by the auction are provided to the requesting media player. In one embodiment, the content item is retrieved from content store 120 by content server 140 and is transmitted to media player 103 via network 104, and the advertisement is retrieved from advertisement store 130 by ad server 141 and is transmitted to media player 103 via network 104. For example, content server 140 notifies ad server 141 about the winning bid and instructs ad server 141 to provide an advertisement associated with the winning bid to media player 103. In another example, content server 140 can instruct media player 103 to request an advertisement associated with the winning bid from ad server 141.

Subsequently, the revenue generated for various content items is shared with respective providers of these content items (e.g., creators of the content items, owners of channels including the content items, etc.).

It should be noted that while the present disclosure is described with respect to two content categories, non-premium and premium, some other implementations may employ more than two content categories (e.g., “super-premium content” in addition to premium and non-premium content, etc.), and it will be clear to those of ordinary skill in the art, after reading this disclosure, how to modify the techniques of the present disclosure to make and use such implementations.

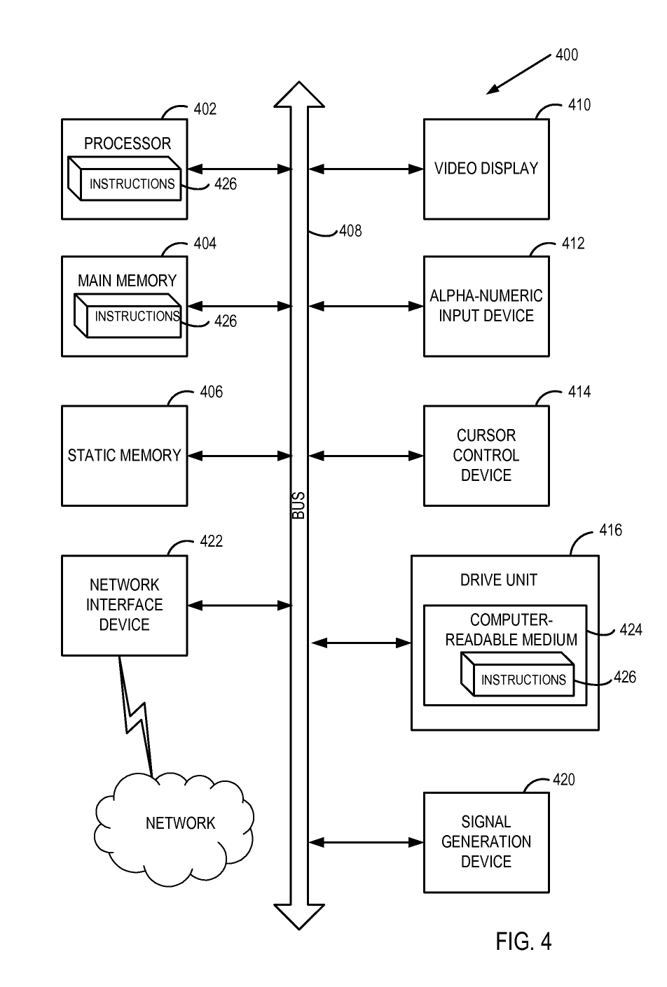

FIG. 4 illustrates an exemplary computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing system (processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)), and a data storage device 416, which communicate with each other via a bus 408.

Processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 may also be one or more special-purpose processing devices such as an application specific integrated circuit (ASIC), a field programmable gate array (FPGA), a digital signal processor (DSP), network processor, or the like. The processor 402 is configured to execute instructions 426 for performing the operations and steps discussed herein.

The computer system 400 may further include a network interface device 422. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

The data storage device 416 may include a computer-readable medium 424 on which is stored one or more sets of instructions 426 (e.g., instructions executed by content server 140, ad server 141, auction manager 142, etc.) embodying any one or more of the methodologies or functions described herein. Instructions 426 may also reside, completely or at least partially, within the main memory 404 and/or within the processor 402 during execution thereof by the computer system 400, the main memory 404 and the processor 402 also constituting computer-readable media. Instructions 426 may further be transmitted or received over a network via the network interface device 422.

While the computer-readable storage medium 424 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “providing,” “receiving,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A method comprising:
receiving a first request for a non-premium content item by a first media player executing on a first client device;
determining, by a processing device, a winning bid for a first auction pertaining to the first request, wherein the winning bid for the first auction is based on an advertiser-specified bid value for advertisement placement in non-premium content;
causing an advertisement associated with the winning bid of the first auction to be provided to the first media player for presentation with the non-premium content item;
receiving a second request for a premium content item by a second media player executing on a second client device;
determining, by the processing device, a winning bid for a second auction pertaining to the second request, wherein the winning bid for the second auction is based on the advertiser-specified bid value and on an advertiser-specified bid modifier for advertisement placement in premium content, wherein the advertiser-specified bid modifier is a mathematical function and wherein determining the winning bid comprises applying the mathematical function to the advertiser-specified bid via a function pointer; and
causing an advertisement associated with the winning bid of the second auction to be provided to the second media player for presentation with the premium content item.

2. The method of claim 1 wherein the advertiser-specified bid value and advertiser-specified bid modifier are associated with a first advertiser, and a second advertiser-specified bid value and a second advertiser-specified bid modifier are associated with a second advertiser.

3. (canceled)

4. The method of claim 1 wherein the second request for the premium content item further requests an advertisement for presentation with the premium content item.

5. The method of claim 1 wherein the winning bid of the second auction is further based on metadata associated with the premium content item.

6. The method of claim 1 wherein the winning bid of the second auction is further based on one or more data associated with the second client device.

7. The method of claim 1 wherein the winning bid of the second auction is further based on one or more data associated with a user of the second media player.

8. An apparatus comprising:
a network interface device; and
a processing device, operatively coupled to the network interface device, to:
receive a first request for a non-premium content item by a first media player executing on a first client device,
determine a winning bid for a first auction pertaining to the first request, wherein the winning bid for the first auction is based on an advertiser-specified bid value for advertisement placement in non-premium content,
cause an advertisement associated with the winning bid of the first auction to be provided, via the network interface device, to the first media player for presentation with the non-premium content item,
receive a second request for a premium content item by a second media player executing on a second client device,
determine a winning bid for a second auction pertaining to the second request, wherein the winning bid for the second auction is based on the advertiser-specified bid value and on an advertiser-specified bid modifier for advertisement placement in premium content, wherein the advertiser-specified bid modifier is a mathematical function and wherein the processing device determines the winning bid by applying the mathematical function to the advertiser-specified bid via a function pointer, and
cause an advertisement associated with the winning bid of the second auction to be provided, via the network interface device, to the second media player for presentation with the premium content item.

9. The apparatus of claim 8 wherein the advertiser-specified bid value and advertiser-specified bid modifier are associated with a first advertiser, and a second advertiser-specified bid value and a second advertiser-specified bid modifier are associated with a second advertiser.

10. (canceled)

11. The apparatus of claim 8 wherein the second request for the premium content item further requests an advertisement for presentation with the premium content item.

12. The apparatus of claim 8 wherein the winning bid of the second auction is further based on metadata associated with the premium content item.

13. The apparatus of claim 8 wherein the winning bid of the second auction is further based on one or more data associated with the second client device.

14. The apparatus of claim 8 wherein the winning bid of the second auction is further based on one or more data associated with a user of the second media player.

15. A non-transitory computer-readable storage medium having instructions stored therein, which when executed, cause a processing device to:
receive a first request for a non-premium content item by a first media player executing on a first client device;
determine, by the processing device, a winning bid for a first auction pertaining to the first request, wherein the winning bid for the first auction is based on an advertiser-specified bid value for advertisement placement in non-premium content;
cause an advertisement associated with the winning bid of the first auction to be provided to the first media player for presentation with the non-premium content item;
receive a second request for a premium content item by a second media player executing on a second client device;
determine, by the processing device, a winning bid for a second auction pertaining to the second request, wherein the winning bid for the second auction is based on the advertiser-specified bid value and on an advertiser-specified bid modifier for advertisement placement in premium content, wherein the advertiser-specified bid modifier is a mathematical function and wherein the instructions cause the processing device to determine the winning bid by applying the mathematical function to the advertiser-specified bid via a function pointer; and
cause an advertisement associated with the winning bid of the second auction to be provided to the second media player for presentation with the premium content item.

16. The non-transitory computer-readable storage medium of claim 15 wherein the advertiser-specified bid value and advertiser-specified bid modifier are associated with a first advertiser, and a second advertiser-specified bid value and a second advertiser-specified bid modifier are associated with a second advertiser.

17. (canceled)

18. The non-transitory computer-readable storage medium of claim 15 wherein the second request for the premium content item further requests an advertisement for presentation with the premium content item.

19. The non-transitory computer-readable storage medium of claim 15 wherein the winning bid of the second auction is further based on metadata associated with the premium content item.

20. The non-transitory computer-readable storage medium of claim 15 wherein the winning bid of the second auction is further based on one or more data associated with the second client device.
